(19) United States
(12) Patent Application Publication
(10) Pub. No.: US 2006/0047578 A1
(43) Pub. Date: Mar. 2, 2006

(54) Method and system for processing data related to home and apartment sales and rentals for providing combined and normalized residential data including home and apartment sales and rentals

(75) Inventors: David B. Carolan, Austin, TX (US); Maria Isbell, Austin, TX (US)

Correspondence Address: FORTKORT & HOUSTON P.C., 9442 N. CAPITAL OF TEXAS HIGHWAY, ARBORETUM PLAZA ONE, SUITE 500, AUSTIN, TX, 78759, US

(73) Assignee: Update Publications LP

(21) Appl. No.: 11/088,669

(22) Filed: Mar. 24, 2005

Related U.S. Application Data
(60) Provisional application No. 60/556,006, filed on Mar. 24, 2004.

(51) Int. Cl. G06Q 30/00

(52) U.S. Cl. 705/26

(57) ABSTRACT

A method in a computer system having storage, for facilitating normalized merging of data relating to rental and sales of apartments and homes. Collective data is received which includes apartment data having records relating to rental and sales of apartments and home data having records relating to rental and sales of homes. A standard unit of measurement is provided. The standard unit of measurement is suitable for at least partially describing the apartment data and for at least partially describing the home data. The collective data is normalized based on at least one component of the collective data. As a result, the records of the apartment data can be compared to the records of the home data on an equivalent basis. The term “equivalent basis” is intended to convey the meaning of an “apples-to-apples” basis of comparison.

### FIELD

This disclosure pertains to the processing of data relating to home and apartment sales and rentals for providing combined and normalized residential data including home and apartment sales and rentals.

### BACKGROUND

The effective collection and distribution of information is important to society. Effective collection and distribution provides an important element of infrastructure which supports the society's current efforts to progress through and ultimately conquer the Information Age.

Furthermore, the form in which information is collected is not always the form in which it is needed. Therefore, it can be highly advantageous to transform, or process, information before distributing it.

Thus, the effectiveness of methods and systems for the collection, processing, and distribution of information is of utmost concern to society.

While effective collection, processing, and distribution of information is an ongoing project of society, that project is necessarily limited by the technology available at any given time.

Before the use of technology to collect, process, and distribute information, a person simply used her senses to collect information, her memory and ability to think to process the information, and her power of speech to distribute the information. Later chalk and other writing utensils were used to enable drawing and writing as methods of distributing information. The information contained in these writings and drawings could then be collected by others for subsequent processing and distribution. Of course, human being inventive, technological leaps were made, ultimately culminating in the invention of paper and the printing press.

In recent decades we have seen the Internet come into common use by millions of people and businesses. Essentially, the Internet continues the evolutionary development of the technology supporting the collecting, processing, and distributing information.

Of course, the Internet has specific characteristics which make new techniques possible in the collection, processing, and distribution of information. The invention of such techniques serves to move society forward through the Information Age.

An example of an industry in which collection, processing, and distribution of information is clearly advantageous is the real estate market for new homes.

In the real estate market for new homes, there are two participants which are absolutely essential: home builders and home buyers. However, the market for new homes is relatively large. Due to the large number of homes on the market at any given time, a home buyer can become “lost” in the market, being unable to efficiently locate those homes which would most closely match the buyer's preferences.

This problem is not only felt by home buyers, but also by home builders. For while the home builder would theoretically be satisfied to sell to any buyer, in practice a home builder will be able to sell to a home buyer much more easily if the home matches the buyer's preferences. Therefore, home builders have a need to locate buyers having preferences sufficiently close to the homes built by the builder.

In response to the problems of home buyers and home builders in a large market of new homes, realtors evolved. The function of realtors is to collect information as to what homes are on the market and what preferences are possessed the realtor's home buyers, to process this information by matching buyers to homes as effectively and efficiently as possible, and to distribute the match information to the buyers in guiding them toward appropriate candidate homes.

As populations increase exponentially and even greater numbers of homes are built and placed on the market, the collection of information by the realtor becomes exponentially more difficult. When the realtor reaches his capacity to collect information about the home market, the response is typically to reduce the geographic area served, to reduce the depth of information collected about the area served, or both. Thus the level of service available from realtors to home buyers is constrained.

In an attempt to alleviate the constraint caused by the realtor's limited capacity to collect information, and thereby improve service levels to home buyers, a fourth type of participant began to play the role of “information collector” on behalf of the realtors. These information collectors collect information regarding the home market, process the information, and distribute it to realtors.

Various methods and systems are now used by information collectors in performing these tasks. Many information collectors access county property records and property tax records for information on home sales and process that information to enable distribution of that information to realtors in the form of a printed publication. This additional information can enable realtors to possess valuable information about the home sales market across a greater geographical area than would be possible without such an information collector.

However, county property records and property tax records typically reflect home sales that occurred months or more in the past. Therefore, the use of county property records and property tax records necessarily inserts a significant time delay into the process of collecting information about home sales by the realtor. Moreover, the time required to prepare a printed publication for distribution of the information from the information collector to the realtor results in additional delay.

Some information collectors now use the Internet to distribute home sales information to realtors, as well as directly to home buyers. This can help to reduce or even eliminate the delay attributable to preparing and delivering a printed publication.

However, many problems remain unsolved in the collection of home sales information to support realtors and other participants in the home sales market, one particular problem being a significant need to further reduce the amount of time required to collect home sales information, process that information, and distribute the information to realtors.

This disclosure provides such methods and systems. These and other advantages, as well as additional inventive features, will be apparent from the present disclosure.

### BRIEF DESCRIPTION OF THE DRAWINGS

For a more complete understanding of the present disclosure, and the advantages thereof, reference is now made to the following brief descriptions taken in conjunction with the accompanying drawings, in which like reference numerals indicate like features.

FIG. 1 illustrates a user interface, according to one embodiment taught by the present disclosure.

FIG. 2 illustrates a user interface, according to one embodiment taught by the present disclosure.

FIG. 3 illustrates a user interface, according to one embodiment taught by the present disclosure.

FIG. 4 illustrates a user interface, according to one embodiment taught by the present disclosure.

FIG. 5 illustrates a user interface, according to one embodiment taught by the present disclosure.

FIG. 6 illustrates a user interface, according to one embodiment taught by the present disclosure.

FIG. 7 illustrates a user interface, according to one embodiment taught by the present disclosure.

FIG. 8 illustrates a user interface, according to one embodiment taught by the present disclosure.

FIG. 9 illustrates a user interface, according to one embodiment taught by the present disclosure.

FIG. 10 illustrates a user interface, according to one embodiment taught by the present disclosure.

FIG. 11 illustrates a user interface, according to one embodiment taught by the present disclosure.

FIG. 12 illustrates a user interface, according to one embodiment taught by the present disclosure.

FIG. 13 illustrates a user interface, according to one embodiment taught by the present disclosure.

FIG. 14 illustrates a user interface, according to one embodiment taught by the present disclosure.

FIG. 15 illustrates a user interface, according to one embodiment taught by the present disclosure.

FIG. 16 illustrates a user interface, according to one embodiment taught by the present disclosure.

FIG. 17 illustrates a user interface, according to one embodiment taught by the present disclosure.

FIG. 18 depicts a block diagram of an overall system, according to one embodiment taught by the present disclosure.

FIG. 19 depicts a schematic diagram of a data entry interface, according to one embodiment taught by the present disclosure.

FIG. 20 depicts a block diagram of an overall system, according to one embodiment taught by the present disclosure.

FIG. 21 depicts a flowchart showing an information collection process, according to one embodiment taught by the present disclosure.

FIG. 22 depicts a schematic diagram of a data structure for collected information, according to one embodiment taught by the present disclosure.

FIG. 23 depicts a block diagram of an overall system, according to one embodiment taught by the present disclosure.

FIG. 24 depicts a block diagram of a process for authorization of a master account and sub-accounts, according to one embodiment taught by the present disclosure.

FIG. 25 depicts a block diagram of logical relationships within an overall system, according to one embodiment taught by the present disclosure.

FIG. 26 depicts a flowchart showing a process of collecting, processing, and distributing apartment and home data, according to one embodiment taught by the present disclosure.

FIG. 27 depicts a flowchart showing a messaging process, according to one embodiment taught by the present disclosure.

FIG. 28 depicts a flowchart showing a process of merging and normalizing home and apartment data, according to one embodiment taught by the present disclosure.

FIG. 29 depicts a flowchart showing a real-time information distribution process, according to one embodiment taught by the present disclosure.

FIG. 30 depicts a flowchart showing a process for implementing community, according to one embodiment taught by the present disclosure.

FIG. 31 depicts a block diagram of community relationships, according to one embodiment taught by the present disclosure.

### DETAILED DESCRIPTION

This disclosure provides a method for collecting, processing, and distributing residential data. Client accounts are established. A message is transmitted to the client accounts requesting the submission of primary residential data. The primary data is then received, including primary apartment data relating to apartment rental events and primary home data relating to home sale events. The primary residential data is normalized on a real-time basis to cause the primary apartment data and the primary home data of the resulting normalized primary residential data to be comparable on an equivalent basis. This equivalent basis can be described as an “apples-to-apples” to basis. Normalized secondary residential data is generated based on the normalized primary residential data on a real-time basis. The normalized secondary residential data and the normalized primary residential data is enabled to be accessed via a full-time public network on a real-time basis.

This disclosure also provides a computer-readable signal capable of being propagated across a full-time public network, the signal carrying computer-readable instructions executable for enabling the performing of a method for collecting data to facilitate real time access and efficient reporting. A sub-account is authorized by a master account, via the full-time public network, to submit primary data associated with a set of residential property. A reminder message is transmitted to the sub-account requesting that the sub-account submit the primary data. The primary data is received from the sub-account via the full-time public network. A known inquiry is received from a remote computer user via the full-time public network. Real-time secondary data at least partially based on the primary data is transmitted to the remote user via the full-time public network.

In addition, this disclosure teaches a method in a computer system having storage, for facilitating normalized merging of data relating to rental and sales of apartments and homes. Collective data is received which includes apartment data having records relating to rental and sales of apartments and home data having records relating to rental and sales of homes. A standard unit of measurement is provided. The standard unit of measurement is suitable for at least partially describing the apartment data and for at least partially describing the home data. The collective data is normalized based on at least one component of the collective data. As a result, the records of the apartment data can be compared to the records of the home data on an equivalent basis. The term “equivalent basis” is intended to convey the meaning of an “apples-to-apples” basis of comparison.

The disclosure also teaches a method for facilitating real time access across a full-time public network and efficient reporting functionality. Pre-existing data is provided in a database server which is communicably coupled to the full-time public network. Fresh data is received via the full-time public network and recorded on a real-time basis in the database server. Access to the database server by the submission of one or more queries originating from client computing devices is enabled across the full-time public network. In response to such a query real-time return data is provided corresponding to the query, wherein the real-time return data is based on at least a portion of the collective of the pre-existing data and the fresh data.

Furthermore, the disclosure teaches a method for facilitating complex relationship-based interactions among computer-using members of a community, corresponding to a set of computer-using clients. A database system communicably coupled to a full-time, public network is provided, wherein the database system includes collection and distribution functionalities and is configured to make the functionalities accessible via the full-time, public network. Data is recorded in said database defining the community and associating a manager with the community, wherein the manager is a member of the community. The manager is enabled to invite others to join the community in order to become additional members of the community. The manager is enabled to establish common approval items with regard to which two specific members must agree in order to make a decision. The database system is enabled to collect data from the members via the full-time public network. The database system is enabled to receive at least one query from at least one member via the full-time public network. The database system is enabled to distribute data to the members in response to the query via the full-time public network.

Other aspects, objectives and advantages of the invention will become more apparent from the remainder of the detailed description when taken in conjunction with the accompanying drawings.

The present disclosure includes teachings of methods and systems for the collection, processing, and distribution of information related to home sales and apartment rentals, and inventive portions thereof.

Utilization of a full-time public network allows efficient, convenient, and timely collection of home sales and apartment rental information. A client-server model may be used to leverage the full-time public network. But peer-to-peer and other models may be used advantageously in various circumstances and configurations.

Implementation of master accounts and sub-accounts can allow a reduction in the workload and delay involved in collecting information because sub-accounts can be empowered to directly submit information to be collected. Contrast this with submission of information from sub-accounts to a master account for review, followed by submission of the information from the master account for collection. Compound this example with the information coming from the sub-accounts to the master account in a format different from that required to be submitted by the master account for collection.

Reminder messages provide greater and more timely collection of information from master accounts and sub-accounts. For example, a home builder operating as a sub-account can be reminded to submit home sales information for the last week, reducing the likelihood that the home builder will allow additional time to pass before submitting that information.

Merging home sales and apartment rental information provides a great value to people in the market for a residence—i.e., being presently undecided between home ownership and apartment rental. Such merging requires the data to be normalized so that meaningful “apples-to-apples” comparisons can be made. For example, home acquisition and ownership costs can be computationally transformed into information equivalently comparable to apartment rental rates and lease terms. Likewise, apartment rental rates and lease terms can be computationally transformed into information equivalently comparable to home acquisition and ownership costs.

Throughout this application, reference is made to “home sales” and “apartment rental.” However, those terms and related terms as they are used herein include “home sales,” “home rental,” “apartment unit rental,” “apartment unit sales,” as well as the sale or rental of condominiums or other residential units, such as residential time shares.

Likewise, the term home builder and alternative terms are used throughout this disclosure. Those terms are intended to encompass home builders, onsite-managers, new home investors, rental managers, condominium distributors, and any others who engage in selling or renting residential space, whether homes, apartments, or otherwise. Similarly, the term realtor is used to indicate anyone who would benefit by receiving the distributed information.

Real-time distribution of information depends upon timely performance of all required stages of collecting, processing, and distributing the information. Delays in the process serve to reduce the capability to provide information that is real-time. Conversely, a real-time distribution system or method could allow a home builder to submit information for collection on Friday evening which then influences the purchase decision of a home buyer that weekend who is being assisted by a realtor who accessed the newly submitted information.

Likewise, customized querying by information distribution recipients is enabled because information would be available real-time. This would enable customized reports to be generated containing the specific information desired by recipients. Alternatively, standard reports could be provided by email on a daily or even hourly basis, for example, rather than quarterly or monthly.

Implementation of communities allows groups of home builders and realtors to form in order to share information, preferences, and other channels, features, and mechanisms without cross-sharing all aspects of those channels, features, and mechanisms with all other home builders and realtors. Thus, communities can create heightened levels of usability, convenience, and efficiencies.

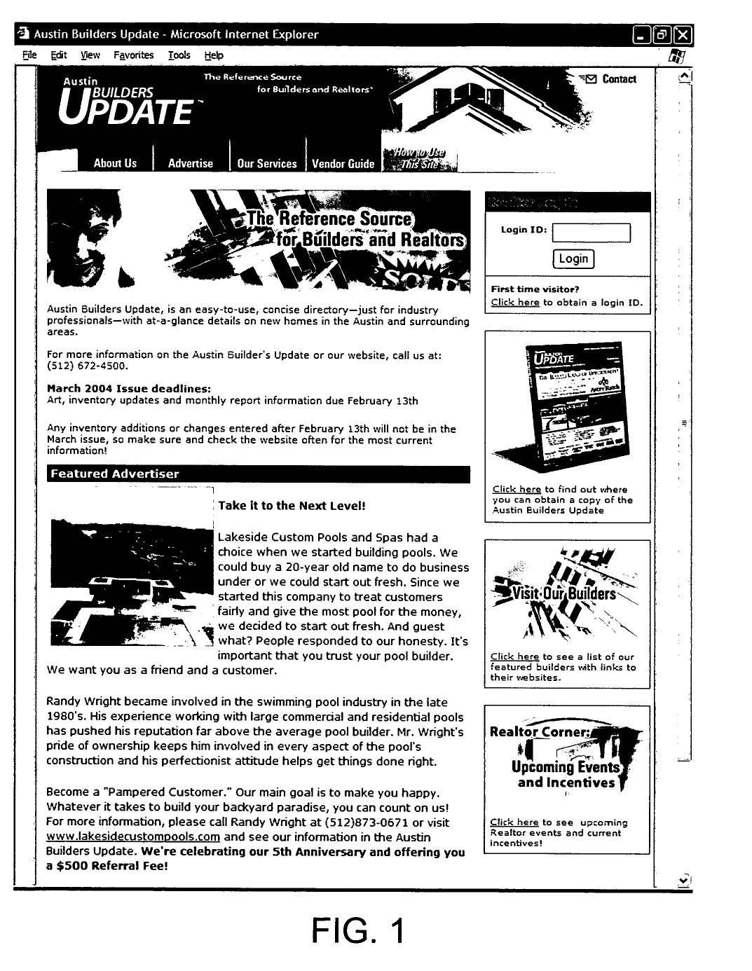

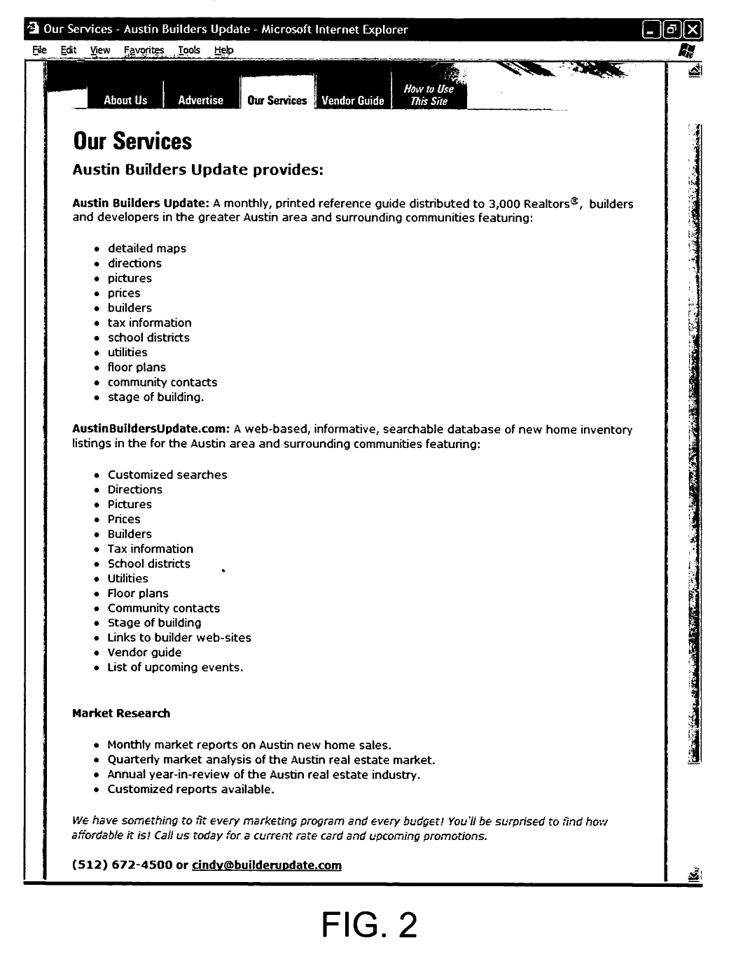

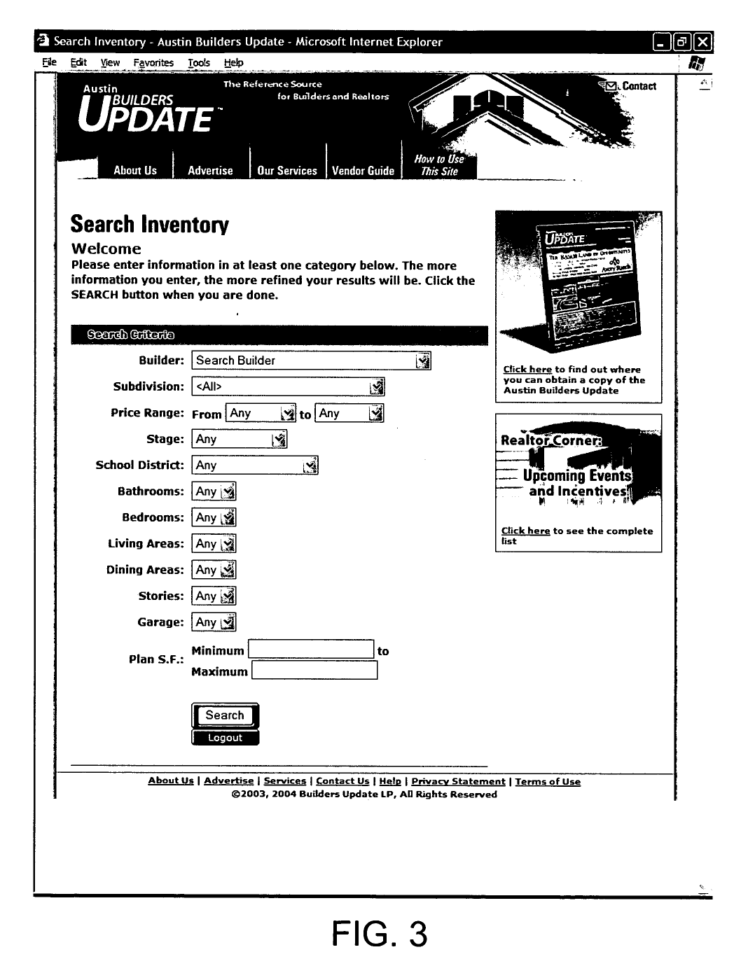

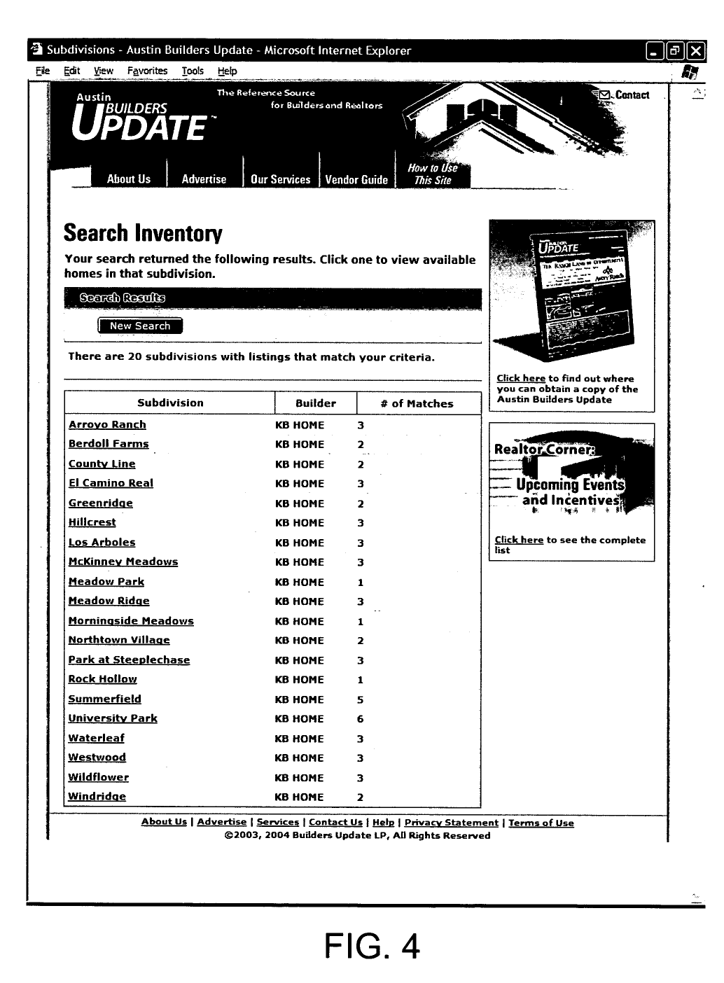

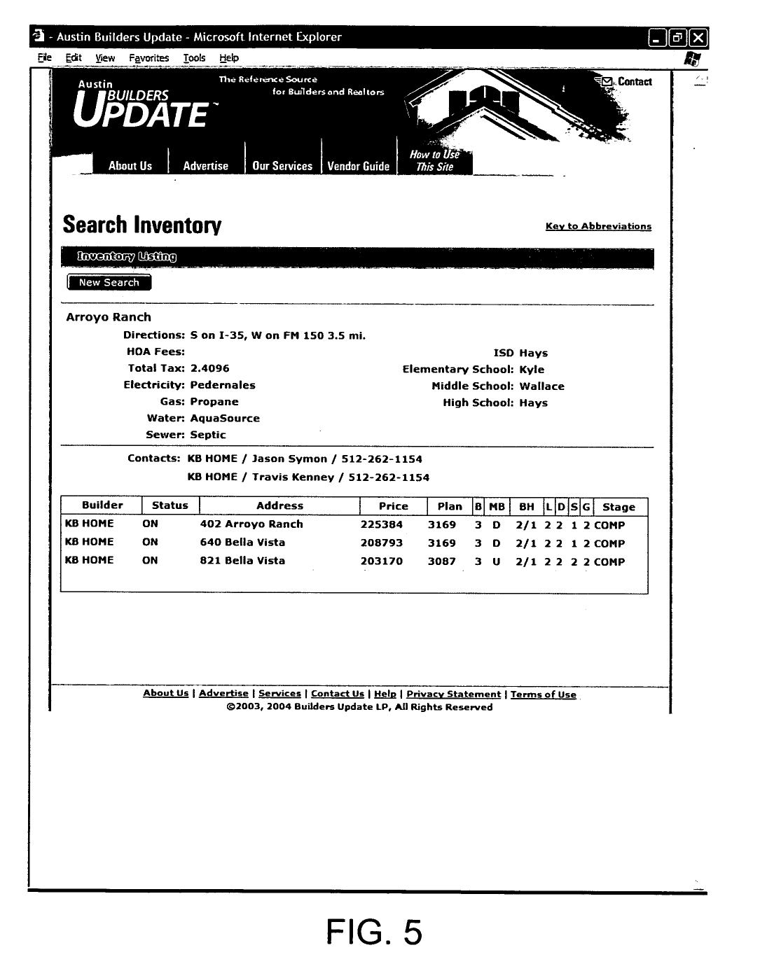

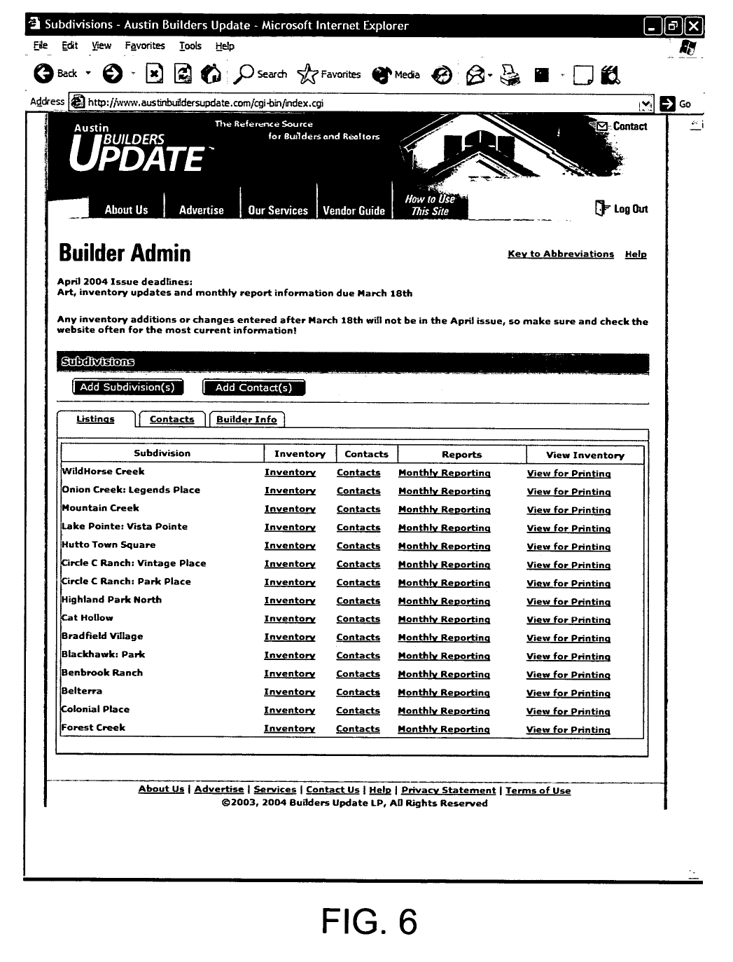

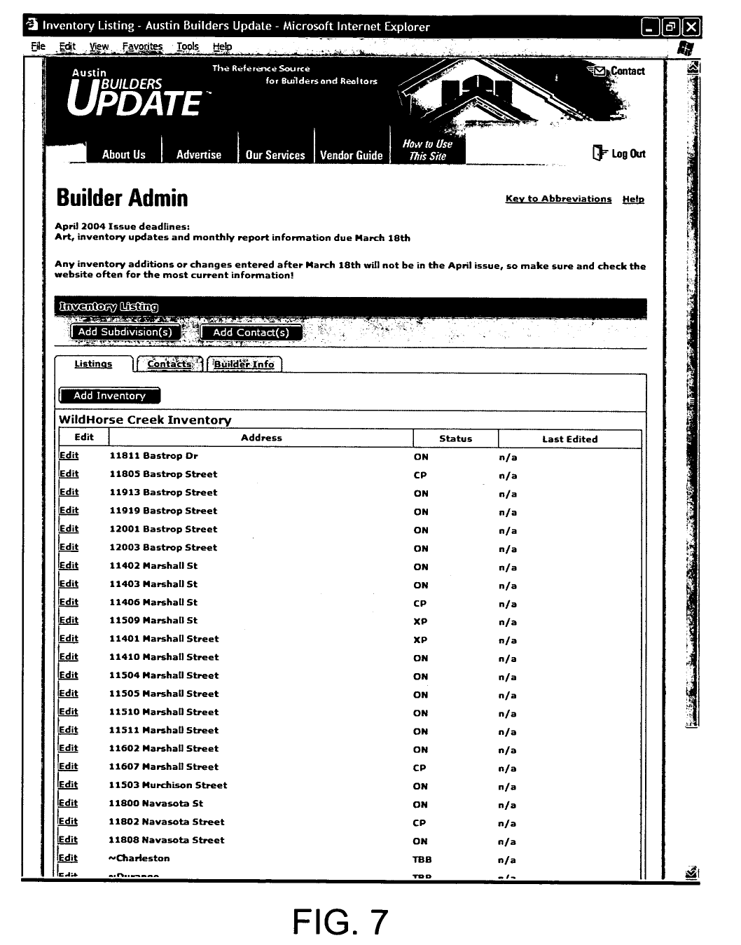

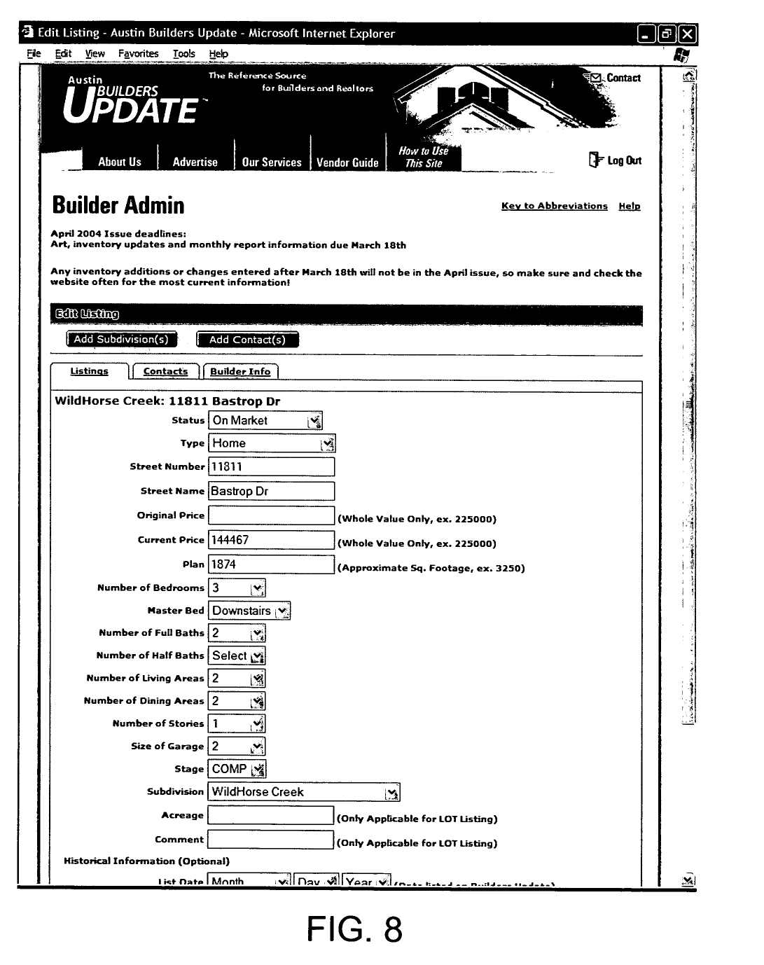

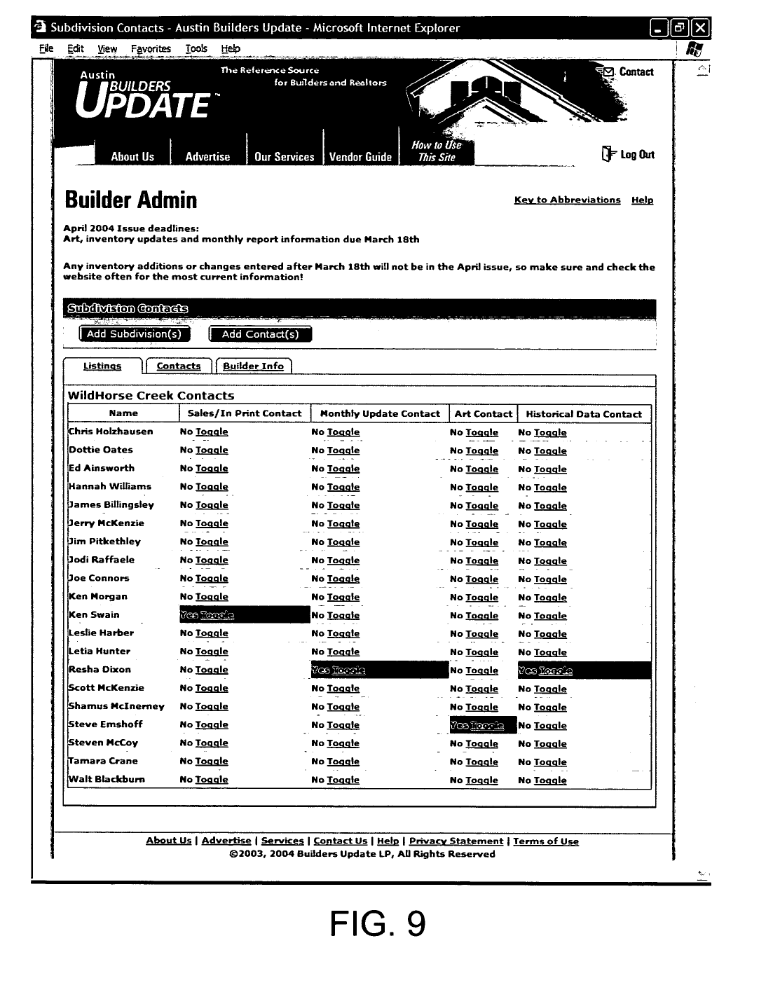

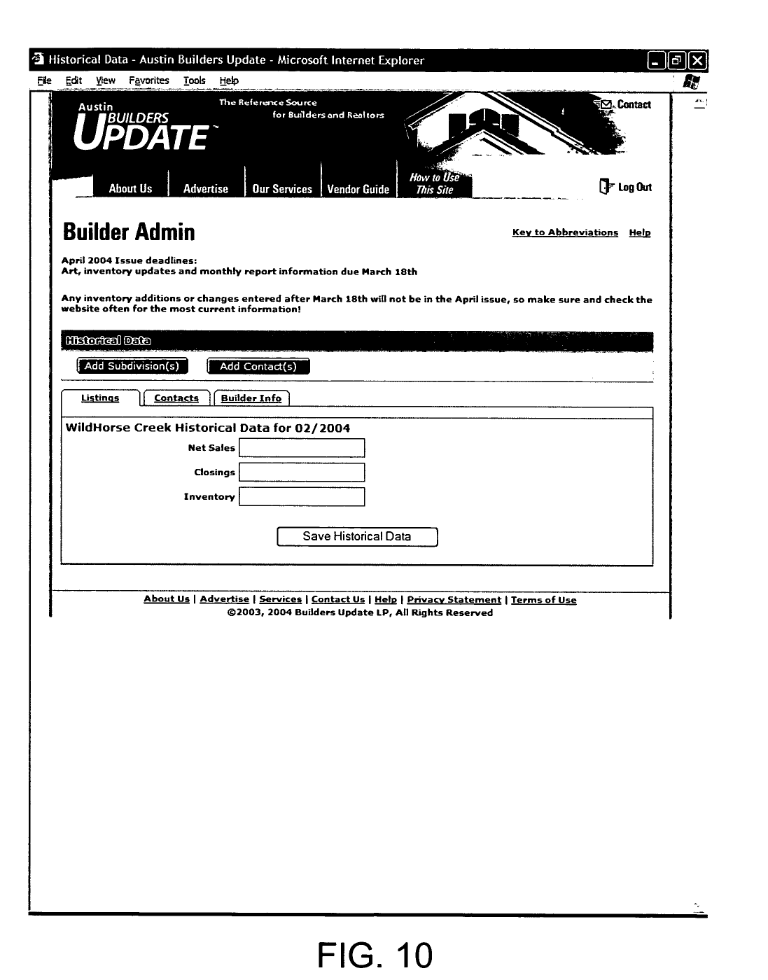

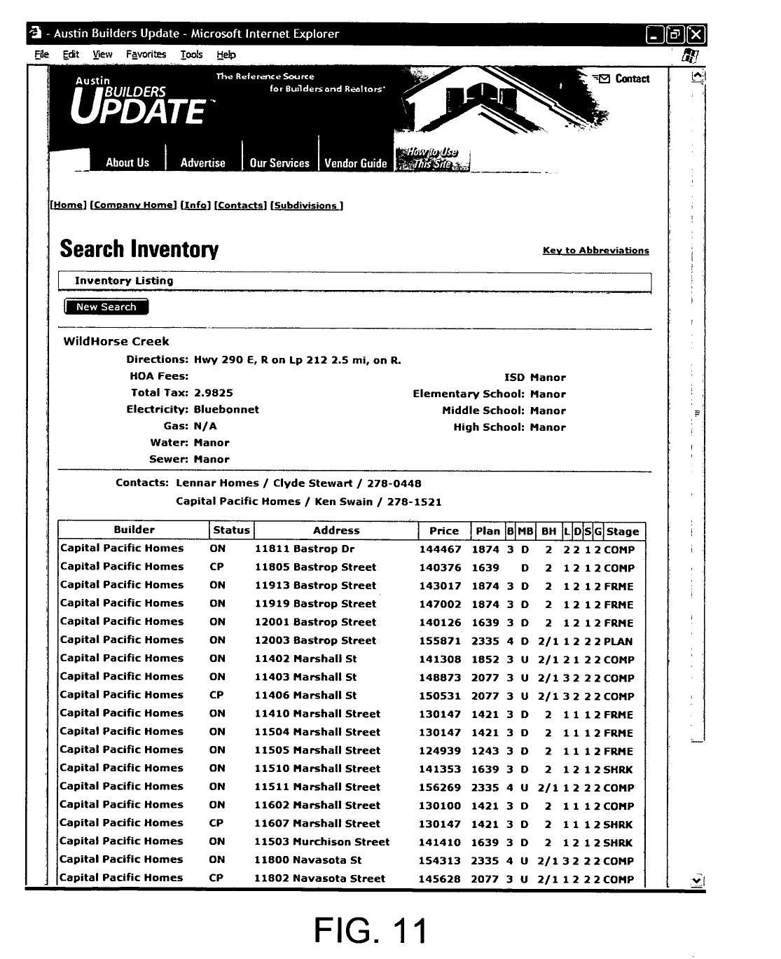

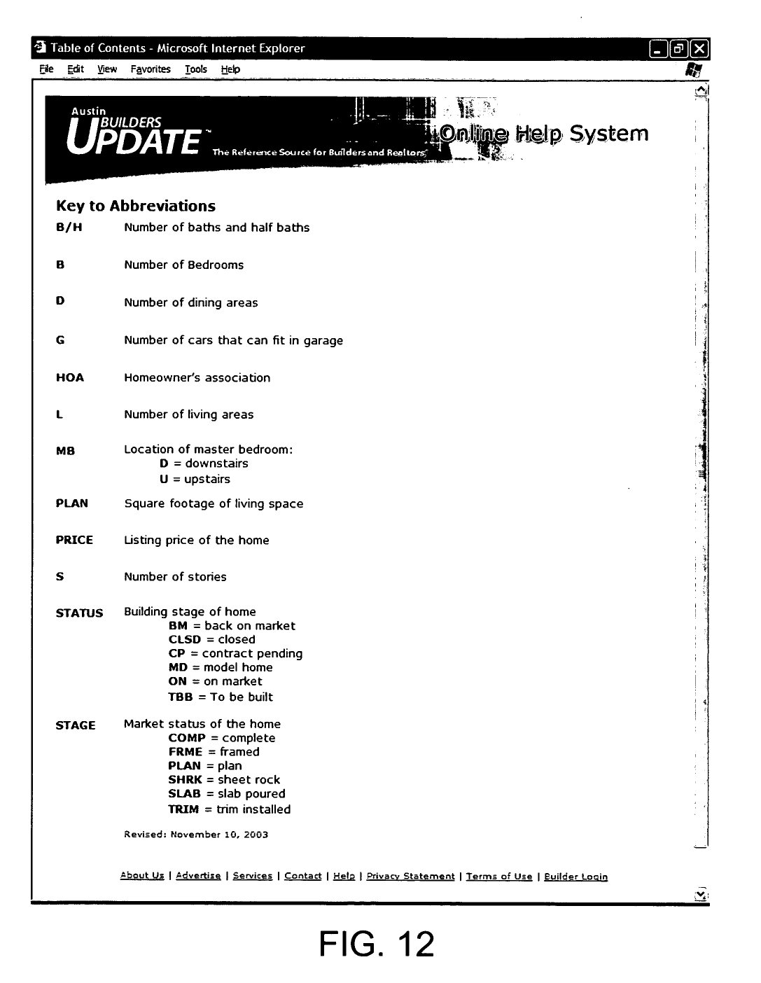

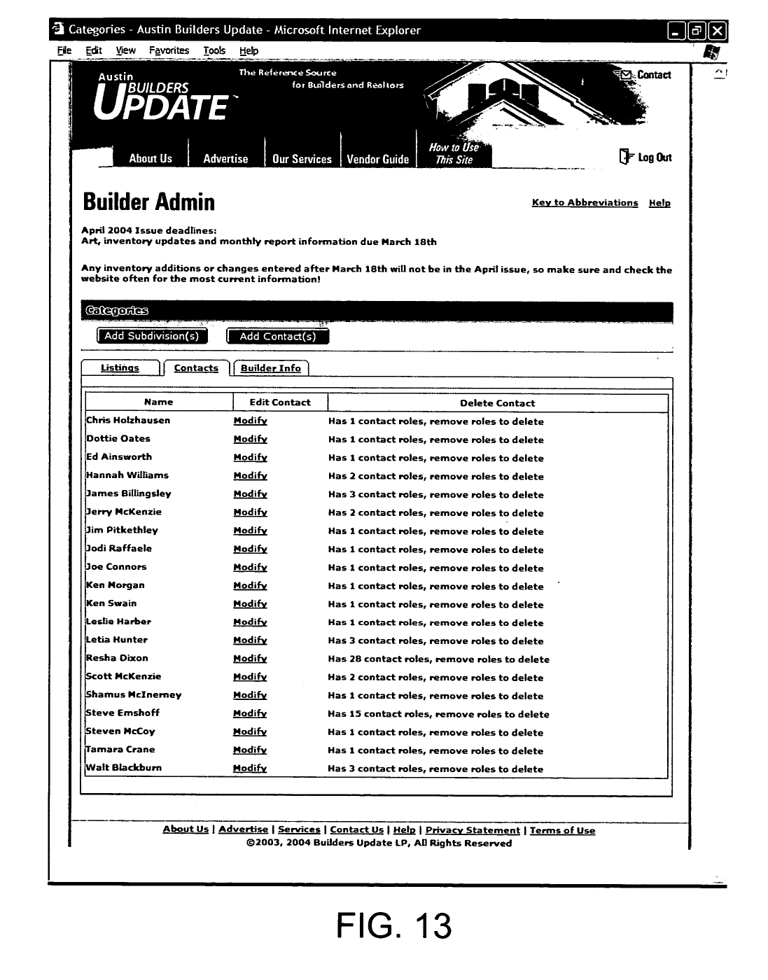

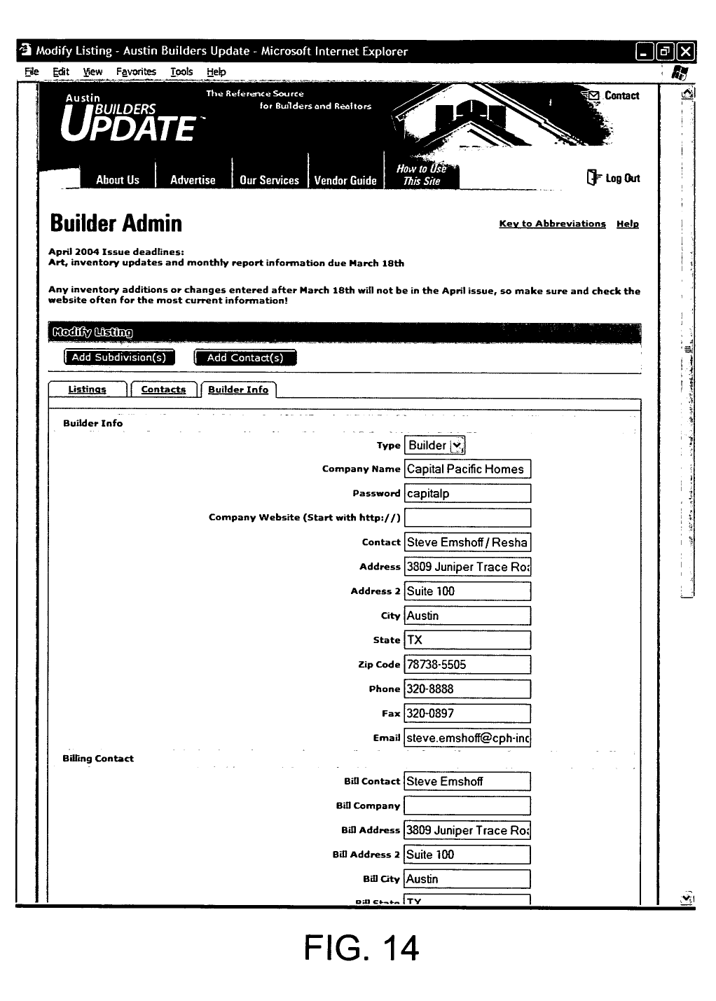

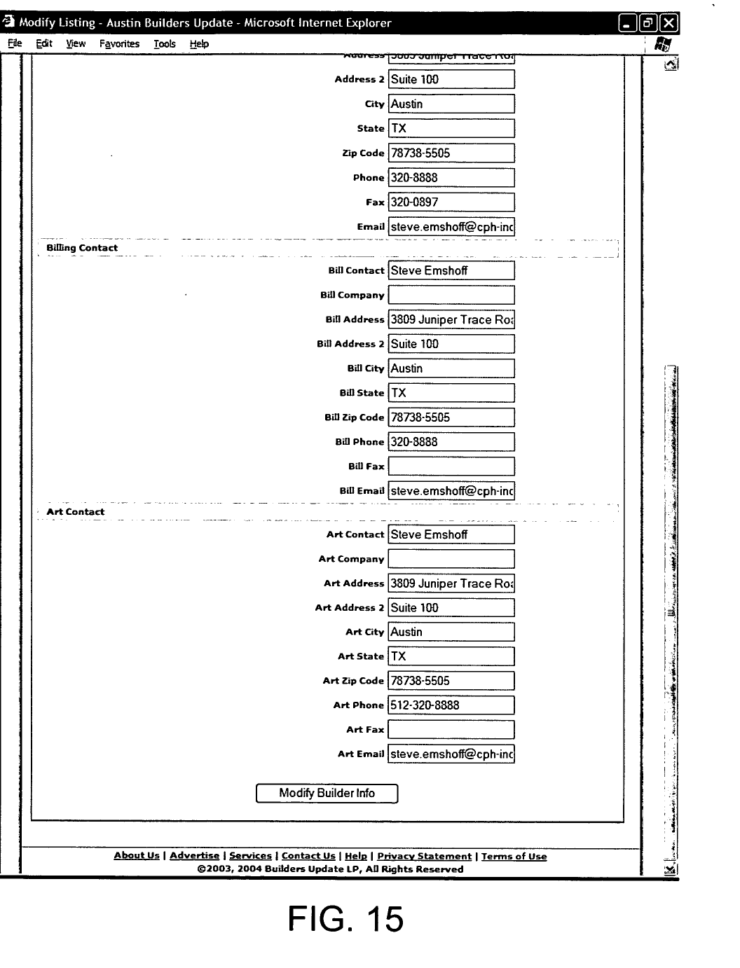

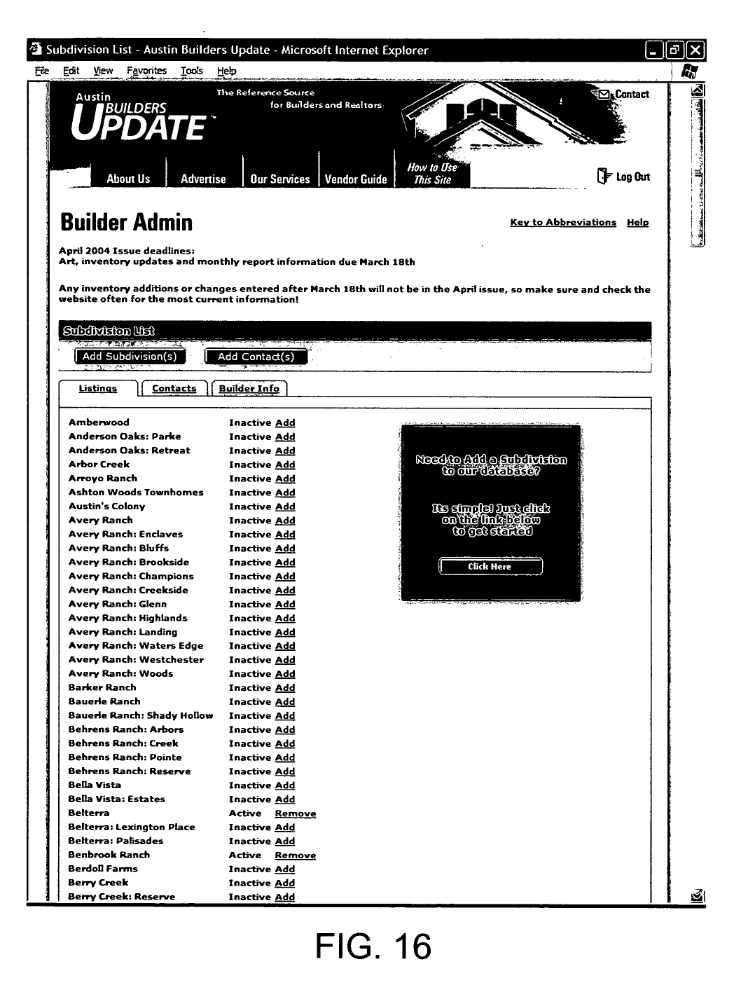

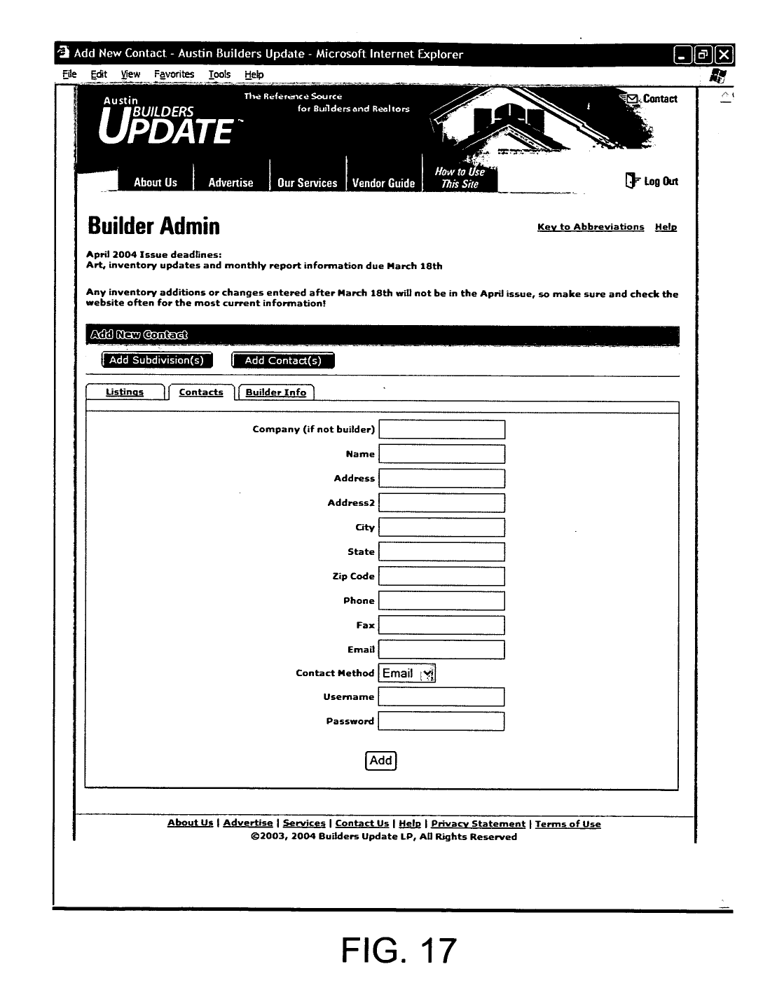

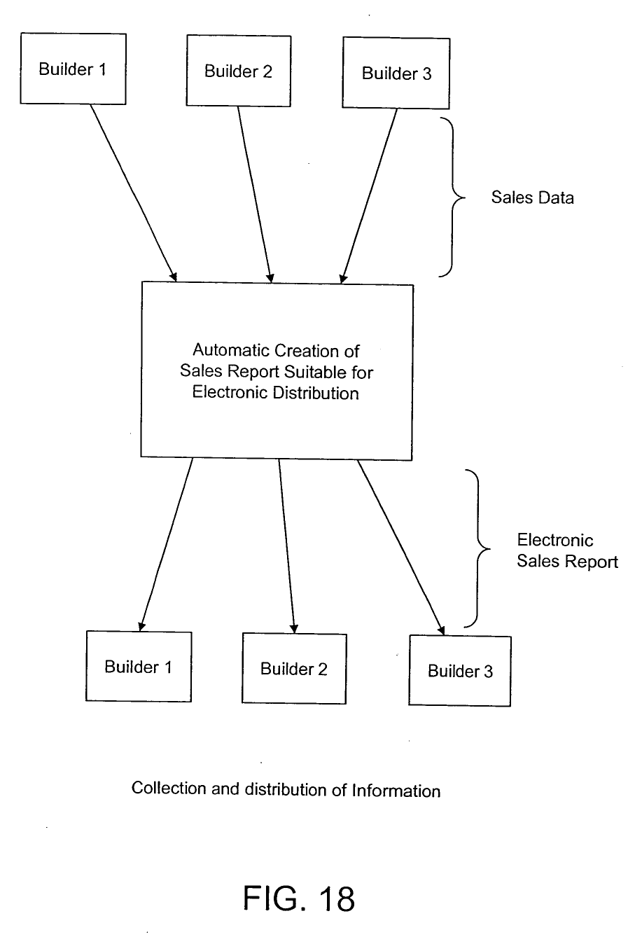

Turning to the drawings, FIGS. 1-17 depict user interfaces through which home builders and realtors might interact with the disclosed systems and methods. The remaining drawings, FIGS. 18-26, depict block diagram examples of some systems and methods.

FIG. 18 depicts a block diagram of an overall system, according to one embodiment taught by the present disclosure. Three builders are depicted inputting sales data. Automatic creation of a sales report suitable for electronic distribution is also shown. Finally, distribution of the report to three builders is shown.

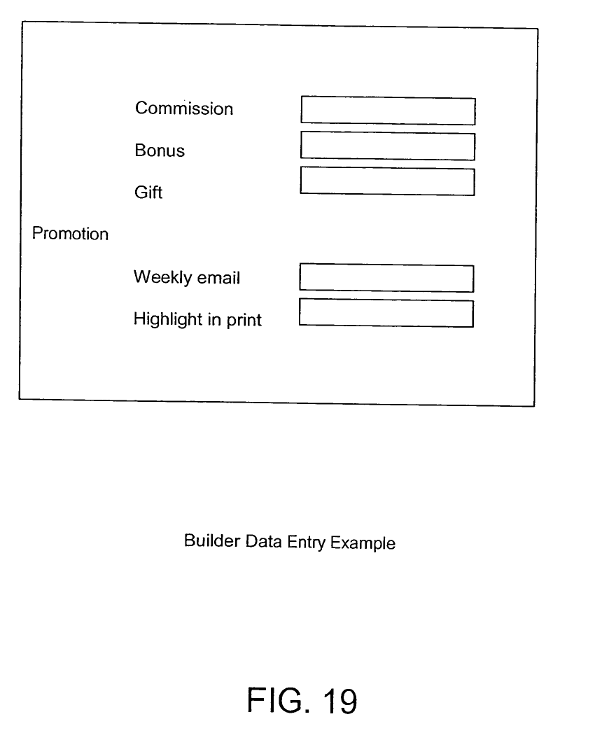

FIG. 19 depicts a schematic diagram of a data entry interface, according to one embodiment taught by the present disclosure. The data entry interface includes entries for the builder to enter commission, bonus, and gift, as well as weekly email promotion and which homes to highlight in print.

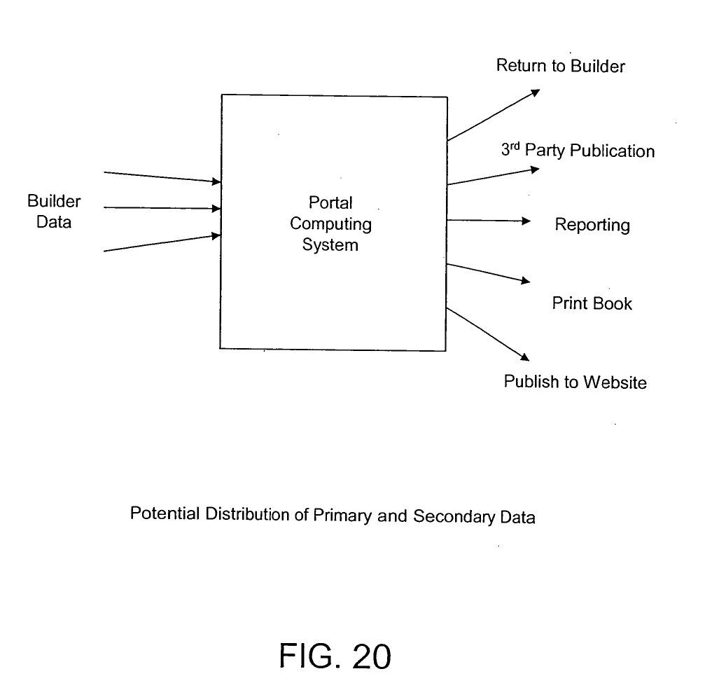

FIG. 20 depicts a block diagram of an overall system, according to one embodiment taught by the present disclosure. The figure illustrates the capability of the system to collect data from multiple builders and distribute data to multiple recipients, including the submitting builders, 3^{rd} parties for publication, reporting channels such as email, pre-printing process for inclusion in a printed publication, and publishing to a web site.

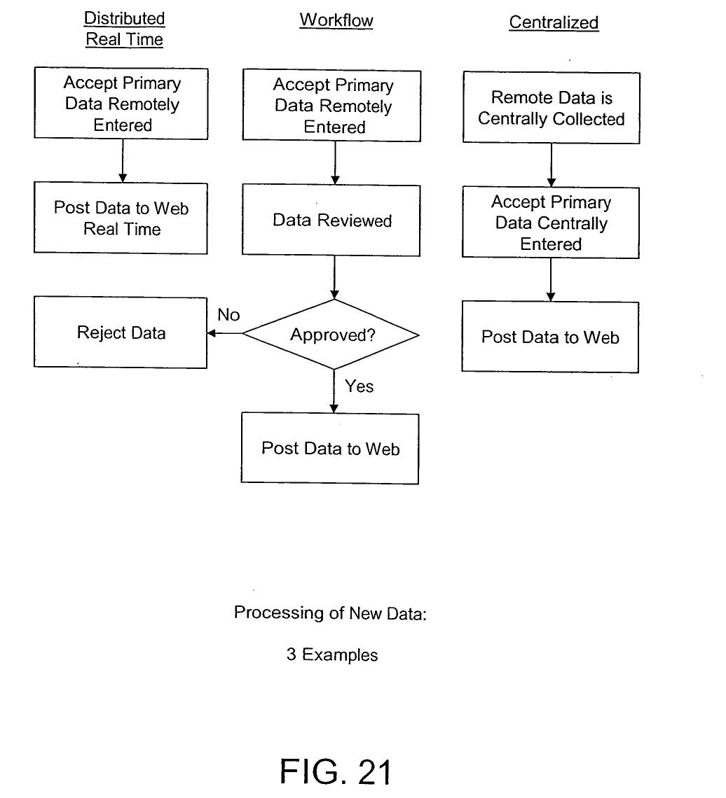

FIG. 21 depicts a flowchart showing an information collection process, according to one embodiment taught by the present disclosure. Data is shown to be distributed real-time, via a managed workflow, or according to a centralized model. Where data is distributed real-time, primary data is accepted as remotely entered and posted real-time on the Web site or other distribution channel. Where data is distributed via a managed workflow, primary is accepted as remotely entered, but it is then subject to a review stage. The review stage can result in the data being either rejected or accepted. In the latter event, the data is posted to the Web site or other distribution channel. Where data is distributed according to a centralized model, remote data is centrally collected, centrally entered, and then posted to the Web site or other distribution channel.

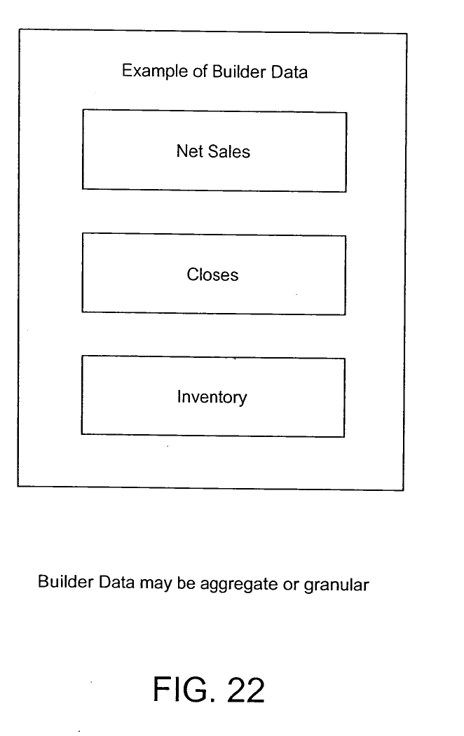

FIG. 22 depicts a schematic diagram of a data structure for collected information, according to one embodiment taught by the present disclosure. The example of builder data includes net sales, closes, and inventory. The information may be more granular or more aggregate, depending on what is collected and how it is processed.

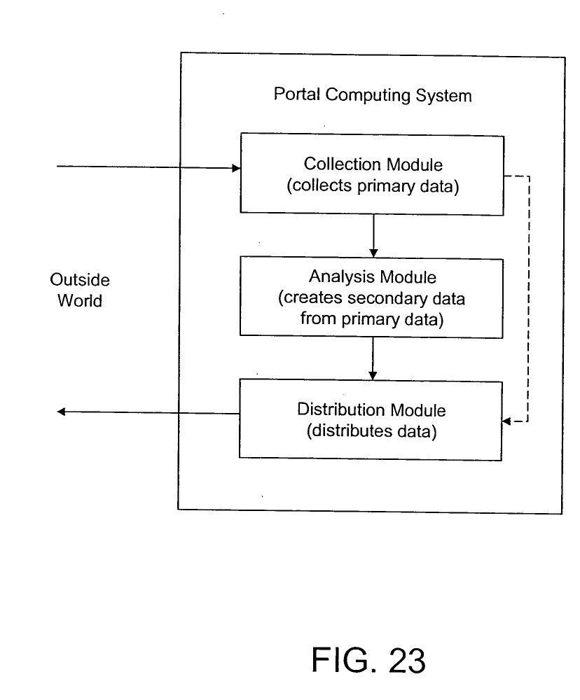

FIG. 23 depicts a block diagram of an overall system, according to one embodiment taught by the present disclosure. The portal computing system collects primary data into a collection module, an analysis module processes the data to create secondary data, and a distribution module distributes data out of the portal computing system.

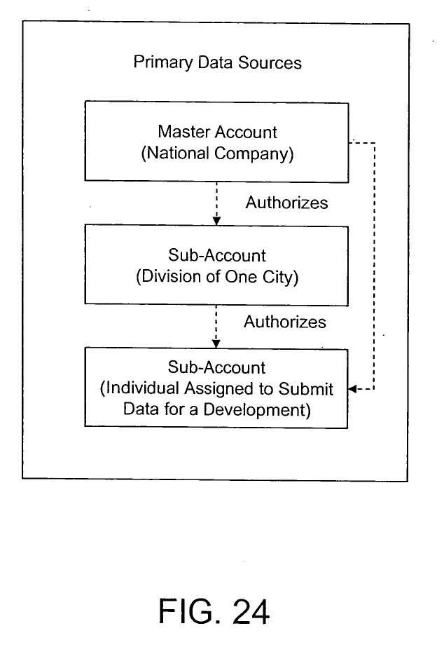

FIG. 24 depicts a block diagram of a process for authorization of a master account and sub-accounts, according to one embodiment taught by the present disclosure. Primary data sources are shown to be a master account and sub-accounts. In the example, the master account represents a national company. The sub-accounts represent a division of one city and an individual assigned to submit data for a development. In the example, the master account authorizes the first sub-account, while the first sub-account authorizes the second sub-account. Alternatively, also shown in the example, the master account authorizes both sub-accounts.

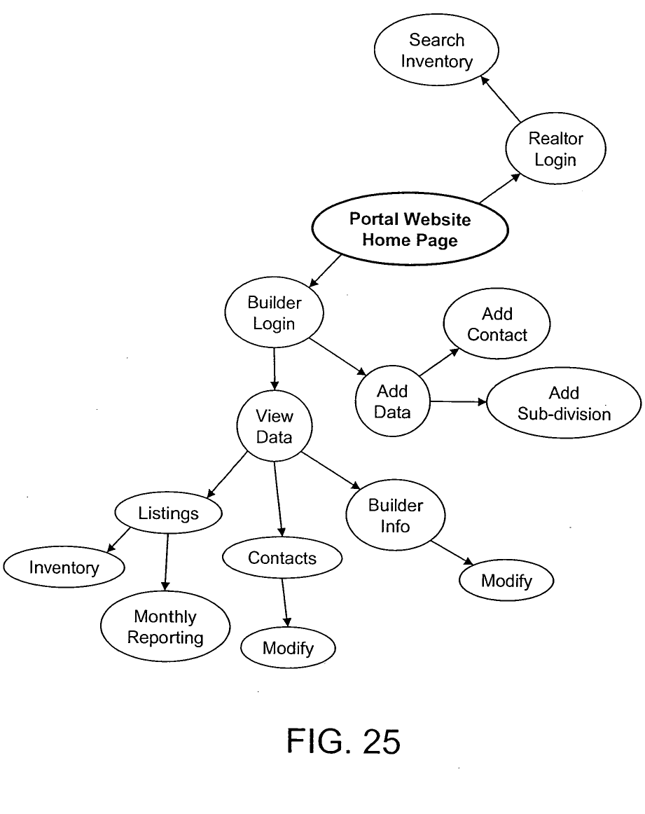

FIG. 25 depicts a block diagram of logical relationships within an overall system, according to one embodiment taught by the present disclosure. A portal website home page is shown. Stemming therefrom are a variety of pages selected for this example which enable collection and distribution of information.

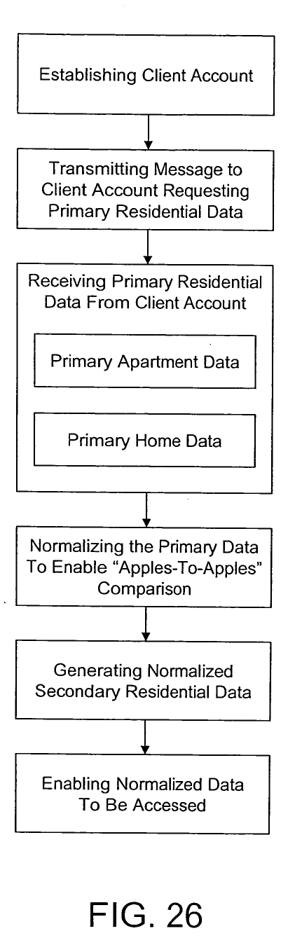

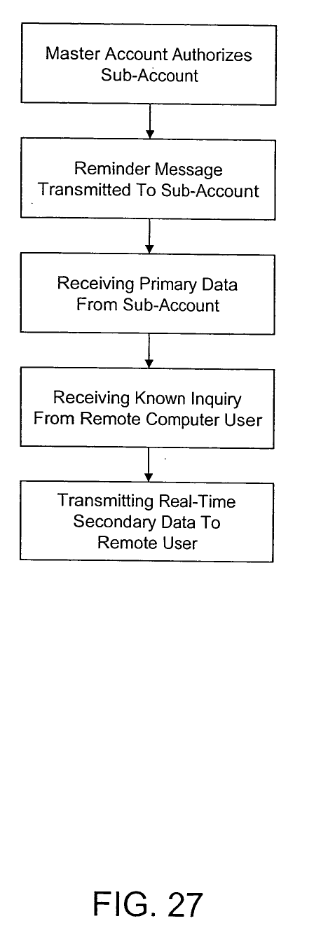

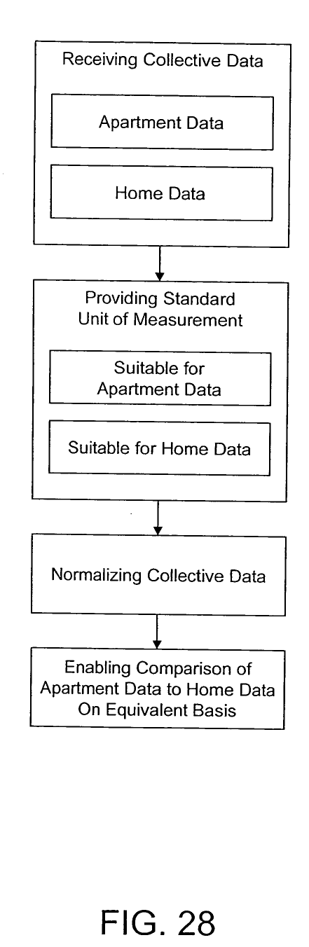

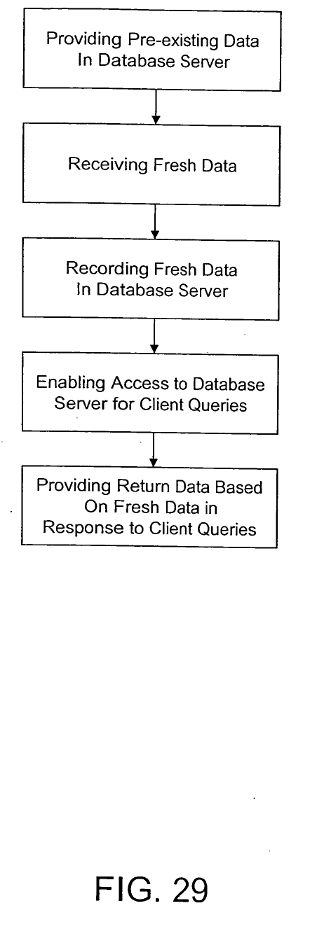

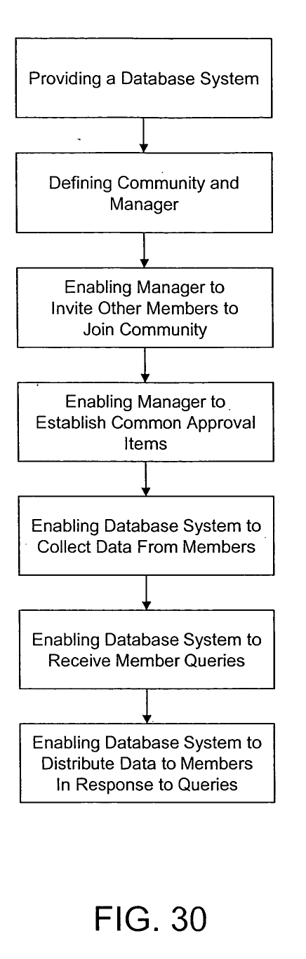

FIG. 26 depicts a flowchart showing a process of collecting, processing, and distributing apartment and home data, according to one embodiment taught by the present disclosure. FIG. 27 depicts a flowchart showing a messaging process, according to one embodiment taught by the present disclosure. FIG. 28 depicts a flowchart showing a process of merging and normalizing home and apartment data, according to one embodiment taught by the present disclosure. FIG. 29 depicts a flowchart showing a real-time information distribution process, according to one embodiment taught by the present disclosure. FIG. 30 depicts a flowchart showing a process for implementing community, according to one embodiment taught by the present disclosure.

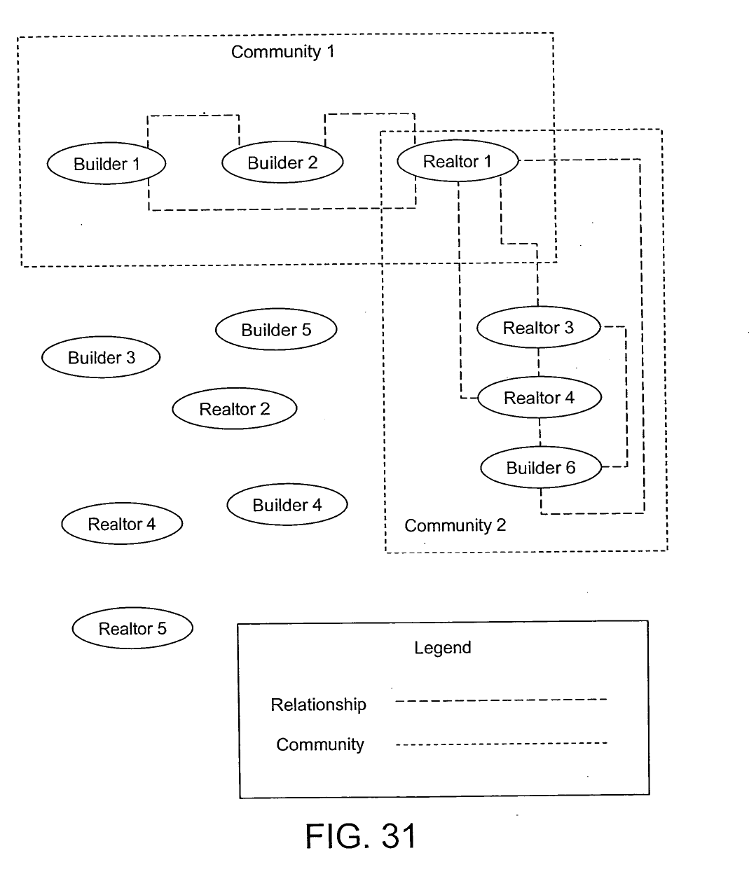

FIG. 31 depicts a block diagram of community relationships, according to one embodiment taught by the present disclosure. Six builders, five realtors, and two communities are shown. Builders 1 and 2 and Realtor 1 are in the first community. Each member of the first community is therefore related to each of the other members of the first community. Builder 6 and Realtors 1, 3, and 4 are in the second community. Note that Realtor 1 is in both communities. Builders 3, 4, and 5 and Realtors 2, 4, and 4 are not members of either community.

Another example of community is a single-seller community implementation. In this example, one builder or apartment manager creates a community. The creator then invites one or more buyers or buyer agents, such as realtors, to join the community as members. The creator makes certain proprietary information available to the members, but not to the general public. In this way, a closer business relationship can be fostered between the creator and the members built on an enhanced flow of information while protecting certain proprietary information of the creator.

APPENDIX 1 contains an 11-page web site and database design and development description related to the present disclosure. APPENDIX 2 contains a 13-page online FAQ for builders related to the present disclosure. APPENDIX 3 contains a 30-page online builder inventory and reports system tutorial related to the present disclosure. APPENDIX 4 contains a 30-page January Market Report 2004 related to the present invention.

All references, including publications, patent applications, and patents, cited herein are hereby incorporated by reference to the same extent as if each reference were individually and specifically indicated to be incorporated by reference and were set forth in its entirety herein.

The use of the terms “a” and “an” and “the” and similar referents in the context of describing embodiments of the invention (especially in the context of the following claims) are to be construed to cover both the singular and the plural, unless otherwise indicated herein or clearly contradicted by context. The terms “comprising,” “having,” “including,” and “containing” are to be construed as open-ended terms (i.e., meaning “including, but not limited to,”) unless otherwise noted. Recitation of ranges of values herein are merely intended to serve as a shorthand method of referring individually to each separate value falling within the range, unless otherwise indicated herein, and each separate value is incorporated into the specification as if it were individually recited herein. All methods described herein can be performed in any suitable order unless otherwise indicated herein or otherwise clearly contradicted by context. The use of any and all examples, or exemplary language (e.g., “such as”) provided herein, is intended merely to better illuminate embodiments of the invention and does not pose a limitation on the scope of the invention unless otherwise claimed. No language in the specification should be construed as indicating any non-claimed element as essential to the practice of the invention.

The term “Primary Data” as used herein means collected data. The term “Secondary Data” means data created based on Primary Data.

Primary data can be collected in the form of individual transactions or in the form of aggregate data representing multiple transactions. In either case, the primary data can then be combined to create highly aggregated data. In addition, the same primary data can be collected more than once, possibly in different forms. For example, home sales in a neighborhood can be collected from the neighborhood builder in the form of individual transactions and also be collected from realtors in the form of aggregate data including transactions occurring within the neighborhood over a period of time. The data collected from each source can then be compared to identify differences, if any. If differences are present, steps could be taken to resolve the inconsistency. Such comparison and resolution could facilitate improved data integrity and could encourage submission of more accurate data.

It is helpful for many participants in the real estate industry to have an overall understanding of the real estate market. In order to achieve and maintain an overall understanding, real estate professionals and others who need an overall understanding of the real estate market, such as developers, appraisers, lenders, potential large employers planning workforce moves, journalists, etc., have been forced to access multiple sources to separately achieve and maintain an understanding of apartment data and home data. One teaching of this disclosure is a solution including normalization which allows apartment data and home data to be compared on an equivalent basis. Accordingly, the term “apples-to-apples” as used herein means facilitating comparison on an equivalent basis.

Preferred embodiments of this invention are described herein, including the best mode known to the inventors for carrying out the invention. Variations of those preferred embodiments may become apparent to those of ordinary skill in the art upon reading the foregoing description. The inventors expect skilled artisans to employ such variations as appropriate, and the inventors intend for the invention to be practiced otherwise than as specifically described herein. Accordingly, this invention includes all modifications and equivalents of the subject matter recited in the claims appended hereto as permitted by applicable law. Moreover, any combination of the above-described elements in all possible variations thereof is encompassed by the invention unless otherwise indicated herein or otherwise clearly contradicted by context.

For example, historical sales information could be collected by the disclosed systems in order to allow trending analysis over a lengthier period of time. In addition, builders could upload and manage their own inventory of homes for sale, including submitting their historical sales.

Another variation in some systems and methods of the disclosed invention generates statistical reports including information on sales, average price, subdivision activity, and builder rankings.

A third modification allows the collection of information followed by distribution of that information to a consumer magazine publisher or other commercial consumer of information in order to facilitate improvement of the consumer magazine's product.

Yet another variation involves implementation of various messaging models. For example, messaging can be used as described above to encourage information sources to submit data. Messaging can also be used to inquire of builders which homes are to be promoted. Security can be enhanced by sending a message a master account upon request by a sub-account related to the master account for a password reminder or upon updating of information falling within the prevue of the master account. Messaging can contain be used to distribute a monthly report in electronic format. Additionally, realtors can be alerted by messaging when a particular home is sold or upon some other trigger event.

Furthermore, all information can be stored in XML or any other format without departing from the spirit and scope of the disclosed invention. The portal website can also maintain one or more calendars with date-related information.

Still another variation is to track information pertaining to apartment locators in order to reduce the potential for fraud. Conventionally, apartment locators physically accompany an apartment seeker to an apartment complex to view a potential unit. While physically at the apartment site, the locator signs in. If the apartment seeker rents the viewed unit, there is then a record indicating that the locator should be paid a commission. However, some apartment locators merely send apartment availability information to apartment seekers and call the apartment site later in an attempt to collect a commission if the apartment seeker has rented the available unit. Apartment sites often pay such locators despite the fact that the locator has not physically signed in. As a result, some dishonest locators call apartment sites seeking commissions on rented apartment units without having send the apartment seeker to view the unit.

The disclosed collection methods and systems can be utilized to gather information pertaining to locators in order to identify locators who repeatedly call requesting commissions without having physically signed in. In addition, the apartment site employee who authorizes such commissions can be tracked do determine whether an employee repeatedly authorizes such commissions. Trending analysis could be utilized to provide yet another view into the resulting data.

What is claimed is:

1. A method in a computer system having storage, for facilitating normalized merging of data relating to rental and sales of apartments and homes, the method comprising the steps of:
receiving collective data which includes:
apartment data comprising at least one record relating to rental and sales of apartments;
home data comprising at least one record relating to rental and sales of homes;
providing a standard unit of measurement:
wherein the standard unit of measurement is suitable for at least partially describing the apartment data;
wherein the standard unit of measurement is suitable for at least partially describing the home data;
normalizing the collective data based on at least one component of the collective data;
whereby the records of the apartment data can be compared to the records of the home data on an equivalent basis.
